(19) United States
(12) Patent Application Publication
(10) Pub. No.: US 2015/0237882 A1
(43) Pub. Date: Aug. 27, 2015

(54) PROCESS FOR PRODUCING OVEN-TYPE CONFECTIONERY PRODUCTS WITHOUT ADDITIVES, FROZEN/LOWERED IN TEMPERATURE, WITH QUICK RECOVERY BEFORE EATING THEM

(71) Applicant: DOLCIARIA ORSOBIANCO S.R.L., Borgo San Dalmazzo (CN) (IT)

(72) Inventor: Luca Bonelli, Borgo San Dalmazzo (IT)

(73) Assignee: DOLCIARIA ORSOBIANCO S.R.L., Borgo San Dalmazzo(CN) (IT)

(21) Appl. No.: 14/436,477

(22) PCT Filed: Oct. 18, 2012
(86) PCT No.: PCT/IT2012/000319

§ 371 Date: Apr. 16, 2015

(51) Int. Cl. A23G 3/34; A23G 9/06; A23L 3/375

(52) U.S. Cl. CPC A23G 3/0004; A23L 3/375; A23G 9/06; A23V 2002/00

(57) ABSTRACT

A process is described for producing oven-type confectionery products without additives, frozen/lowered in temperature, with quick recovery before eating them, that comprises the steps of: completely cooking the confectionery product; immediately freezing/lowering in temperature the cooked confectionery product by using liquid nitrogen; packaging the confectionery product frozen/lowered in temperature; and possibly storing and transporting the packaged confectionery product.

### CROSS-REFERENCE TO RELATED APPLICATION

The present application is a national stage of International Patent Application No. PCT/IT2012/000319, titled “Process For Producing Oven-Type Confectionery Products Without Additives, Frozen/Lowered In Temperature, With Quick Recovery Before Eating Them,” filed Oct. 18, 2012, the contents of which are incorporated in this disclosure by reference in their entirety.

The present invention refers to a process for producing oven-type confectionery products without additives, frozen/lowered in temperature, with quick recovery before eating them.

In order to allow a wider and longer consumption, prolonged in time, the most common oven products (bread, pasta, confectionery), as well as the foodstuff products more in general, have been commonly frozen, in order to be then heated and eaten after a long time with respect to their production.

Freezing, down to a temperature of about −18° C., of oven products is a process that, upon their heating (cooking completion) before their final consumption, implies very long times (on the order of 30 minutes) to obtain a product that can be eaten. Such long times are incompatible with uses of such products that provide for their immediate consumption by users: for example, a cake that must be eaten at breakfast, for which a user must wait for all this time before its consumption, if the stocks of such case gets exhausted.

In order to solve this type of problem, processes (for example like the one disclosed in document U.S. Pat. No. 4,986,992) have been used wherein a partially cooked (around 80%) confectionery product is subjected to immediate freezing by using liquid nitrogen, taking it at a starting temperature of about −4° C. and then at the freezing temperature of −18° C., in a time equal to about 10-11 minutes. In order to allow such working, these confectionery products however provided for the use of additives, which is not optimum for the end product quality.

### SUMMARY OF THE INVENTION

Object of the present invention is providing a process for producing oven-type confectionery products without additives, frozen/lowered in temperature, with quick recovery before eating them, that is simple to make, and that allows obtaining confectionery products that keep their internal structure free from additives and that can be recovered very quickly, obtaining again an end product with the same organoleptic characteristics of the one originally went out of a production oven.

### DETAILED DESCRIPTION OF PREFERRED EMBODIMENTS

The above and other objects and advantages of the invention, as will result from the following description, are obtained with a process as claimed in claim 1. Preferred embodiments and non-trivial variations of the present invention are the subject matter of the dependent claims.

It is intended that all enclosed claims are an integral part of the present description.

The present invention will be better described by some preferred embodiments thereof, provided as a non-limiting example: in fact, it will be immediately obvious that numerous variations and modifications (for example related to steps, quantities and compositions with equivalent functionality) can be made to what is described, without departing from the scope of the invention as appears from the enclosed claims.

According to the invention, a process is provided for producing oven-type confectionery products without additives, frozen/lowered in temperature, with quick recovery before eating them, wherein such process comprises the steps of:

completely cooking the confectionery product, for example in an oven;

immediately freezing/lowering in temperature the cooked confectionery product by using liquid nitrogen, for example using a liquid nitrogen temperature lowering device;

packaging the confectionery product frozen/lowered in temperature, for example in common sealed boxes containing a plurality of products of this type; and

possibly storing in a warehouse, and/or possibly transporting the packaged confectionery product to an end user.

Moreover, such process comprises, before eating the product, the step of subjecting the confectionery product frozen/lowered in temperature to recovery in heating means (for example an oven) at about 200° C. for a period ranging from 3 to 7 minutes.

Alternatively, a step can be provided for taking to ambient temperature the confectionery product frozen/lowered in temperature through staying at ambient temperature for a period of about 1 hour without requiring the use of an oven or other similar hearing means.

In particular, the step of immediately freezing/lowering in temperature through liquid nitrogen occurs by taking the cooked confectionery product to a temperature from −20° C. to −90° C. and keeping the confectionery product at such temperature for a minimum period of 2 minutes.

Moreover, the step of completely recovering the confectionery product occurs in a range of temperatures from 170° C. to 240° C.

The currently more efficient application for producing brioches or croissants is the one in which the step of immediately freezing/lowering in temperature through liquid nitrogen occurs by taking the confectionery product, cooked at a temperature of 200° C., down to a temperature of −60° C. in about 8 minutes and keeping the confectionery product at the temperature of −60° C. for a period of 4 minutes.

With the above described process, it is possible to make confectionery products subjected to lower stresses during preparation and cooking, taking them back, in about 5 minutes of recovery after freezing/lowering in temperature, to their eatable status like the just cooked one, with high saving of times and costs for the end user.

The produced confectionery products are free from conservants and are composted of selected raw materials, that guarantee their final freshness before their consumption. For example, for a product like a brioche, the ingredients used for its preparation are: wheat, butter, sugar, fresh pastorised whole milk, fresh pastorised eggs, absence of monodiglicerydes of fat acids, absence of colorants, conservants and genetically manipulated organisms, glucose syrup, vanilline as single used aroma, and margarine without hydrogenated fats.

The products made with the inventive process can be stored in a range of temperatures from −5° C. to −20° C. and are recovered at about 200° C. for a period from 3 to 7 minutes.

### EXAMPLES

The present invention will be further described by using some application embodiments, provided as a non-limiting example, in order to allow a skilled person in the art to understand the evolution of the inventive process and of the product derived therefrom.

Two tests have been carried out, a cooking test and a test of lowering in temperature for cooked croissants. The test results are included in the two Tables that follow.

Results of cooking tests of croissants w.r.t. times and temperature

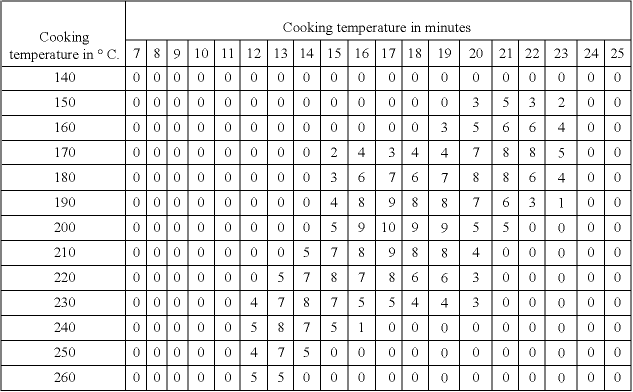

The test has been carried out with various types of croissants, through an internal panel of 7 people who tasted the various samples in different orders. After a negative judgement, the evaluations were stopped since the product was not any more in compliance with the company's quality and storage standards. The evaluation was made on a scale from 0 to 10 where the range of products falling within an evaluation greater than or equal to 8 were deemed acceptable as product meeting the company's quality and the storage requirements.

As can be seen from this first table, the satisfactory results are those pointed out in the light-coloured boxes.

Results of temp.-lowering tests of cooked croissants
w.r.t. times and temperature

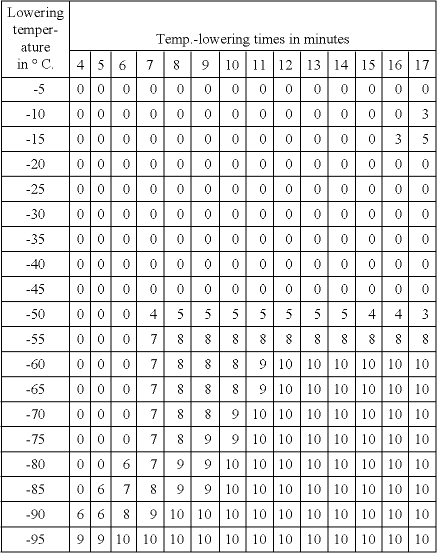

The test has been carried out with various types of croissants, through an internal panel of 7 people who tasted the various samples in different orders. After a negative judgement, the evaluations were stopped since the product was not any more in compliance with the company's quality and storage standards. The evaluation was made on a scale from 0 to 10 where the range of products falling within an evaluation greater than or equal to 8 were deemed acceptable as product meeting the company's quality and the storage requirements.

As can be seen from this second table, the satisfactory results are those pointed out in the light-coloured boxes, or those in the lower right part of the table.

1-6. (canceled)

7. A process for producing oven-type confectionery products without additives, lowered in temperature, with quick recovery before eating them, the process comprising the steps of:
a) cooking a confectionery product completely;
b) immediately lowering the cooked confectionery product temperature using liquid nitrogen;
c) packaging the confectionery product lowered in temperature;
d) storing the packaged confectionery product; and
e) transporting the packaged confectionery product.

8. The process according to claim 7, wherein the step of immediately lowering the temperature of the cooked confectionery product using liquid nitrogen is accomplished by lowering the temperature from −20° C. to −90° C. and keeping the confectionery product at that temperature for a minimum time of 2 minutes, using liquid nitrogen.

9. The process according to claim 7, where in the step of immediately lowering the temperature of the cooked confectionery product is accomplished by taking the confectionery product, cooked at a temperature of 200° C., down to a temperature of −60° C. in about 8 minutes and keeping the confectionery product at the temperature of −60° C. for a period of 4 minutes using liquid nitrogen.

10. The process according to claim 7, further comprising the step of recovering the confectionery product lowered in temperature by heating at about 200° C. for a time period ranging from 3 to 7 minutes.

11. The process according to claim 7, further comprising the step of returning the confectionery product to ambient temperature by placing the confectionery product at ambient temperature for a period of about 1 hour.

12. The process according to claim 7, further comprising the step of returning the confectionery product to a cooked temperature by heating the confectionery product to a temperature between 170° C. to 240° C.
